(19) United States
(12) Patent Application Publication
(10) Pub. No.: US 2015/0006386 A1
(43) Pub. Date: Jan. 1, 2015

(54) OFFLINE MOBILE PAYMENT PROCESS

(71) Applicant: Harald Tebbe, Heidelberg (DE)

(72) Inventor: Harald Tebbe, Heidelberg (DE)

(73) Assignee: SAP AG, Walldorf (DE)

(21) Appl. No.: 13/966,053

(22) Filed: Aug. 13, 2013

Related U.S. Application Data
(60) Provisional application No. 61/840,614, filed on Jun. 28, 2013.

(51) Int. Cl. G06Q 20/40

(52) U.S. Cl. CPC G06Q 20/40
USPC 705/44

(57) ABSTRACT

A payment system transmits an authorization token to a mobile device. The authorization token enables the mobile device to create a barcode. The system receives from a point of sale device, in connection with reading the barcode, the authorization token and information relating to a product or service for purchase. The system validates the authorization token, and compares the information relating to the product or service with information associated with a virtual payment account. In response to the comparison, the system either authorizes the purchase or denies the purchase. The system transmits the authorization or denial to the point of sale device, and applies a purchase amount to the virtual payment account.

### TECHNICAL FIELD

The current disclosure relates to a mobile payment process, and in an embodiment, but not by way of limitation, a mobile payment process having offline capabilities.

### BACKGROUND

During sporting events like soccer and ice hockey, there are thousands of people at an event location. In general, such an event has one or two breaks of around fifteen minutes apiece. During these breaks, crowds of visitors would like to buy merchandise, food, and/or beverages. To avoid long lines and waiting periods on the one hand, and on the other hand to maximize revenue, the entire sales process has to be streamlined. One potential way to streamline this process involves the payment process. In particular, paying by cash can take quite long as the customer has to count his or her money, and then the cashier has to count again to verify the amount of the cash. Alternatively, a customer can pay by a debit or other card, but payment by card may also be quite slow since the customer has to enter the pin into a terminal or sign a bill.

Consequently, many sport arenas require payment by special RFID cards. Use of an RFID card to pay for goods or services involves the following. A customer has to buy such a special card in advance and upload money (pre-payment) to the card. When the customer wants to buy something at a food court or in a merchandise shop, the only option to pay is by using such a card. The customer places the card onto a special device (card reader), the pre-payment amount is reduced in a fraction of a second, and the process is finished. The customer does not have to enter a pin or sign a bill or count cash. As a result, the payment process is very efficient and fast. However, a disadvantage to such pre-paid RFID cards is that not many people want buy such a card and carry it as yet another card in his or her wallet.

### BRIEF DESCRIPTION OF THE DRAWINGS

FIG. 1 is a block diagram illustrating an example embodiment of an offline mobile payment system.

FIG. 2 is another block diagram illustrating an example embodiment of an offline mobile payment system.

FIGS. 3A and 3B are a block diagram illustrating operations and features of an offline mobile payment process and system.

FIG. 4 is a block diagram of a computer system in connection with which embodiments of the present disclosure can operate.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

An embodiment includes a mobile scenario with smart phones that offers the advantages described above in connection with prepaid cards, but avoids the disadvantage wherein a customer has to buy and carry an additional card in his or her wallet.

To prepare to use an embodiment disclosed herein, a customer creates a virtual account using mobile wallet software, which acts also as an authorization server during a payment process. The customer can store different payment methods and different payment information in the account. For example, the virtual account can include information relating to, and/or that is associated with, a bank account for a direct debit scenario, credit card information in order to implement a credit card payment, and a prepaid account in which the customer transfers money to the virtual account.

The offline portion of the embodiment involves the following. Currently, there are already several mobile payment variants out in the market. However, for all of these variants, the mobile phone needs to communicate with the authorization server during the payment process via the Internet (via e.g., 3G, WLAN, etc.). However, in a sports arena, the data connection of a mobile phone is normally not very good. Consequently, in an embodiment, the mobile payment process is configured to be offline capable. This is accomplished as follows.

A customer installs an application on his or her smart phone, wherein the customer enters the user credential of his or her mobile wallet where he or she has a pre-payment account. The application communicates regularly, when there is an Internet/data connection available, with a central authorization server of the mobile wallet to get authorization tokens. The authorization tokens are stored in the application, and the tokens have a validity of a configurable time frame (e.g., 1 hour). Thereafter, the customer buys articles in a shop and would like to pay at a check out system (e.g., Point of Sales (PoS), Web shop, etc). Now, instead of offering an RFID card to a card reader, the application creates a barcode (e.g., a QR Code) on the display unit of the user's smart phone that can include several pieces of information such as the authorization token, a customer identification, and a loyalty identification. The authorization token is mandatory, while the customer identification and loyalty identification are optional.

The cashier scans the barcode that is displayed on the user's smart phone via a two-dimensional barcode scanner, and a cash desk application on the POS device decrypts the information. The barcode and the scanner are more or less simply a way of data transfer. In an embodiment, instead of transferring the data via barcode and scanner, near field communication (NFC) could be used. However, not all smartphones offer NFC functionality. After the POS application decrypts the information, it sends the relevant information (authorization token) to the authorization server, which validates the token and approves or declines the authorization. After that, the authorization token is consumed and not useable anymore. It is noteworthy that the POS application in general has a stable and fast internet connection, which is able to request an authorization in a fraction of a second. After this, the payment process in general is finished. The authorization server offers the payment information to the smartphone application so that the application shows the payment as soon as the smartphone has a stable internet connection again.

Consequently, an embodiment allows a user to pay with a smart phone instead of carrying several cards, pay with a smart phone in an environment where no internet connection is available, and pay with a smart phone in a very efficient way, faster than by cash or by card wherein a user has to enter a pin or sign a bill.

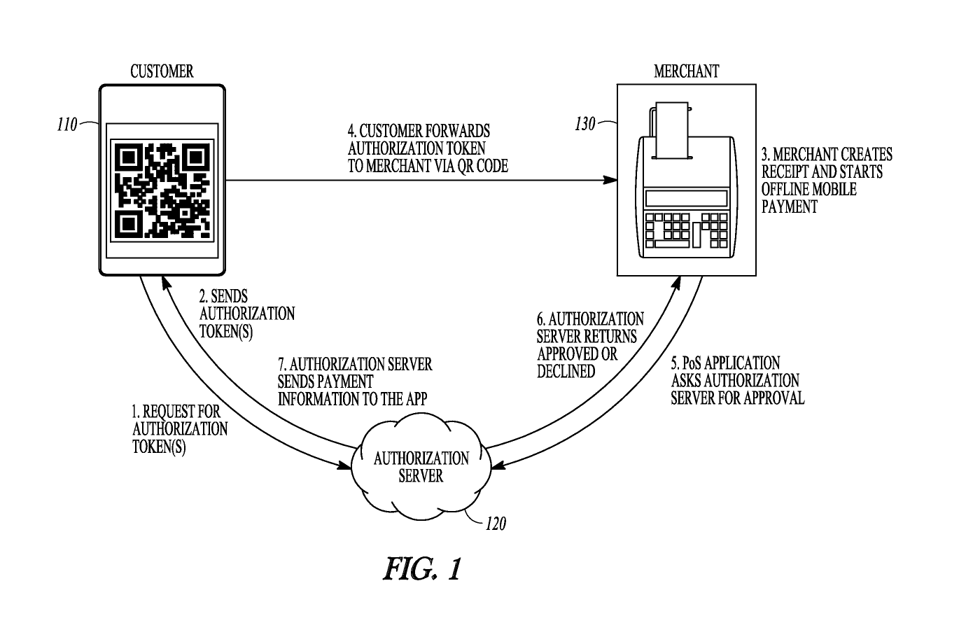

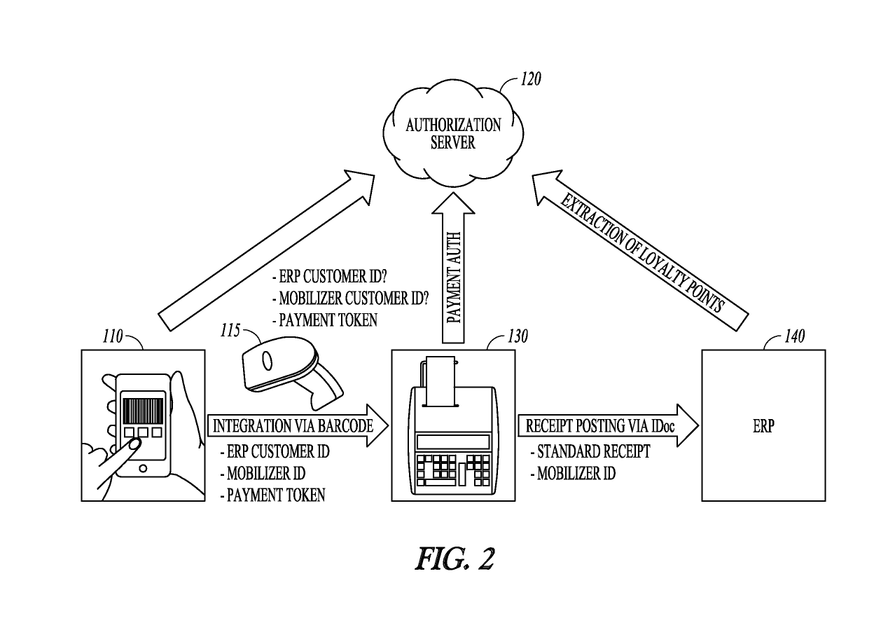

FIGS. 1 and 2 illustrate components of a system embodiment for an offline mobile payment system. Referring first to FIG. 1, a customer mobile device 110 requests an authorization token from an authorization server 120. The authorization server 120 sends an authorization token to the customer mobile device 110. The mobile device uses the authorization token to create a bar code or quality code, and displays the bar code or quality code on the display screen of the mobile device. A point of sale device (POS) 130 at a merchant location reads the bar code or quality code, and seeks approval for the transaction from the authorization server 120. The authorization server 120 notifies the POS device 130 of the approval or disapproval of the purchase. The authorization server 120 further sends payment information to the mobile device 120.

Referring now to FIG. 2, an embodiment is illustrated that includes integration with an enterprise resource planning (ERP) system. FIG. 2 illustrates several of the components illustrated in FIG. 1, specifically, a mobile device 110, an authorization server 120, and a POS device 130. FIG. 2 further illustrates a scanning device 115 that is associated with the POS device 130. FIG. 2 illustrates that the mobile device 110 requests an ERP customer ID, a mobilizer customer ID, and a payment token from the authorization server 120. The ERP customer ID can be used in connection with a loyalty program. The mobilizer customer ID can be used in connection with a mobile wallet. Consequently, in an embodiment, a system can include an ERP system and a separate mobile wallet system. A customer can have an ID in one system and a different ID in another system. As noted above, the customer ID and the mobilizer ID are optional. The mobile device 110 then provides the ERP customer ID, the mobilizer ID, and the payment token to the POS device 130. The POS device 130 requests payment authorization from the authorization server 120. The POS device 130 also transmits the mobilizer ID and a standard receipt to the ERP system 140.

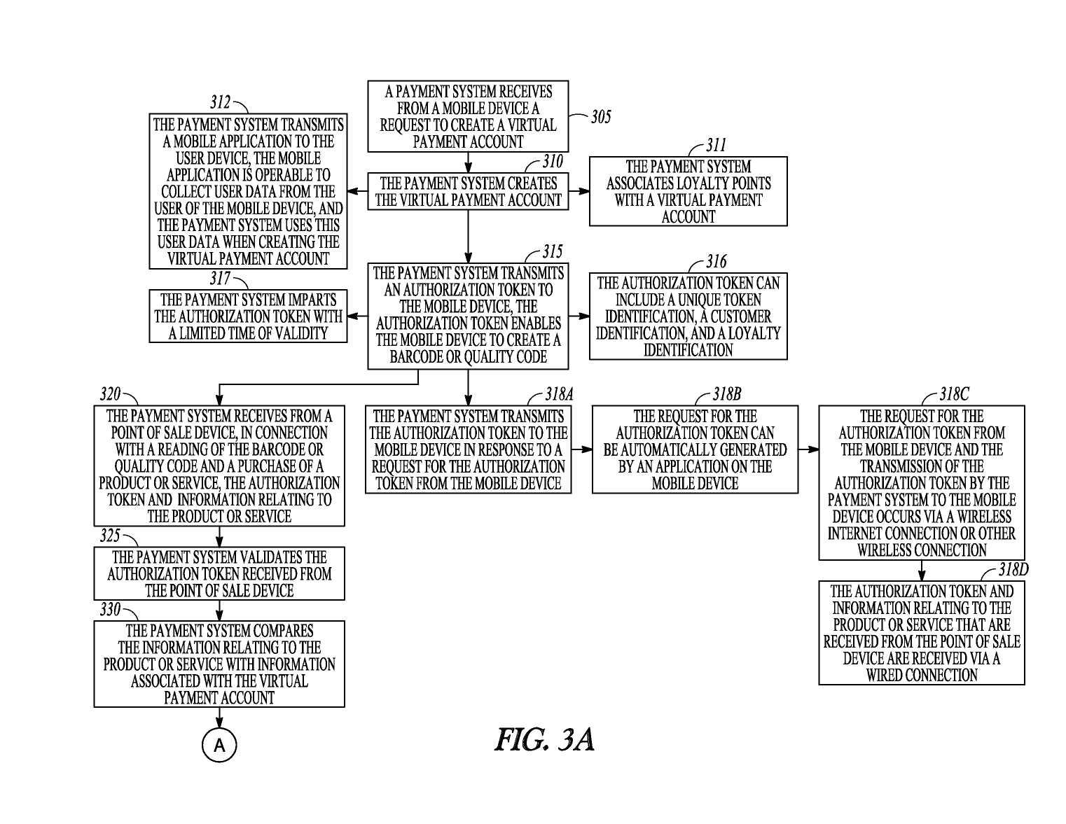

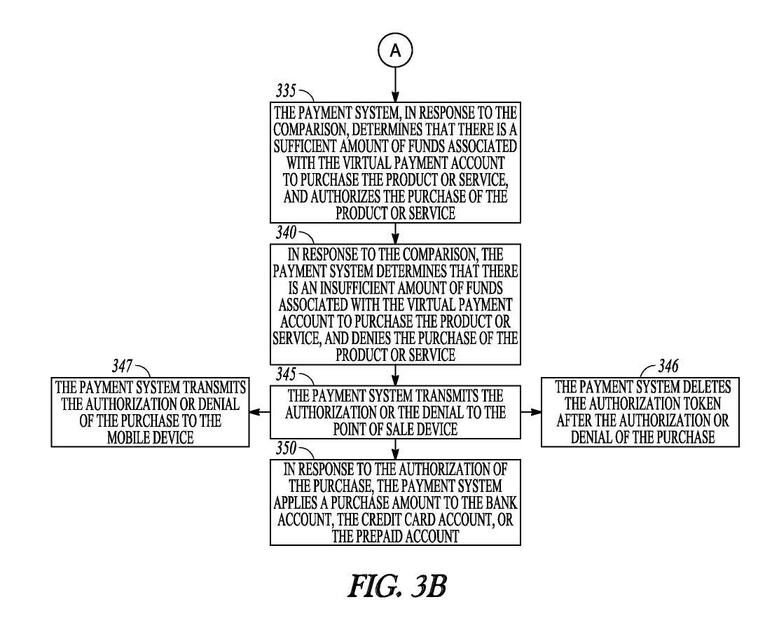

FIGS. 3A and 3B are a block diagram illustrating operations and features of an offline mobile payment process and system. FIGS. 3A and 3B include a number of operation and process blocks 305-350. Though arranged serially in the example of FIGS. 3A and 3B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now to FIGS. 3A and 3B, at 305, a payment system receives from a mobile device a request to create a virtual payment account. The virtual payment account is associated with one or more of a bank account, a credit card account, and a prepaid account. At 310, the payment system creates the virtual payment account. In some embodiments, as illustrated at 311, the payment system is operable to associate loyalty points with the virtual payment account. At 312, the payment system transmits a mobile application to the user device. The mobile application is operable to collect user data from the user of the mobile device. The payment system can use this user data when creating the virtual payment account.

At 315, the payment system transmits an authorization token to the mobile device. The authorization token is associated with the virtual payment account, and the authorization token is configured such that the authorization token enables the mobile device to create a barcode or quality code. The barcode or quality code includes the authorization token. Block 316 indicates that the authorization token can include a unique token identification, customer identification, and a loyalty identification. The unique token identification includes a format that the payment system can recognize as a valid token, and a unique identifying number and letter combination for each token. Each customer has his or her own unique customer number that can be associated with the token. Some embodiments include a loyalty identification, which identifies a particular buyer loyalty program with which the customer is associated. At 317, the payment system imparts the authorization token with a limited time of validity. For example, an authorization token may only be valid for an hour. In other embodiments, the authorization token may be valid for 3-4 hours, that is, the approximate length of a sporting event. An effect of the limited validity time of the authorization tokens is that the payment system has to keep track of a smaller number of authorization tokens.

At 318A, the payment system transmits the authorization token to the mobile device in response to a request for the authorization token from the mobile device. This request can be initiated by the user of the mobile device, or as indicated at 318B, it can be automatically generated by an application on the mobile device. As noted at block 318C, the request for the authorization token from the mobile device and the transmission of the authorization token by the payment system to the mobile device occurs via a wireless Internet connection or other wireless connection. In contrast, as indicated in block 318D, the authorization token and information relating to the product or service that are received from the point of sale device are received via a wired connection. As noted above, the wired connection at the point of sale is much more stable than a wireless connection of a mobile device, especially in a venue such as a sports arena.

At 320, the payment system receives from a point of sale device, in connection with a reading of the barcode or quality code and a purchase of a product or service, the authorization token and information relating to the product or service. At 325, the payment system validates the authorization token received from the point of sale device, and at 330, compares the information relating to the product or service with information associated with the virtual payment account. At 335, the payment system, in response to the comparison, determines that there is a sufficient amount of funds associated with the virtual payment account to purchase the product or service, and authorizes the purchase of the product or service. At 340, in response to the comparison, the payment system determines that there is an insufficient amount of funds associated with the virtual payment account to purchase the product or service, and denies the purchase of the product or service.

At 345, the payment system transmits the authorization or the denial to the point of sale device. At 346, the payment system is operable to delete the authorization token after the authorization or denial of the purchase. After authorization or denial of the transaction, the particular authorization token that was used is no longer needed, so the payment system cleanses itself of authorization tokens that are no longer needed. At 347, the payment system transmits the authorization or denial of the purchase to the mobile device. Finally, at 350, in response to the authorization of the purchase, the payment system applies a purchase amount to the bank account, the credit card account, or the prepaid account.

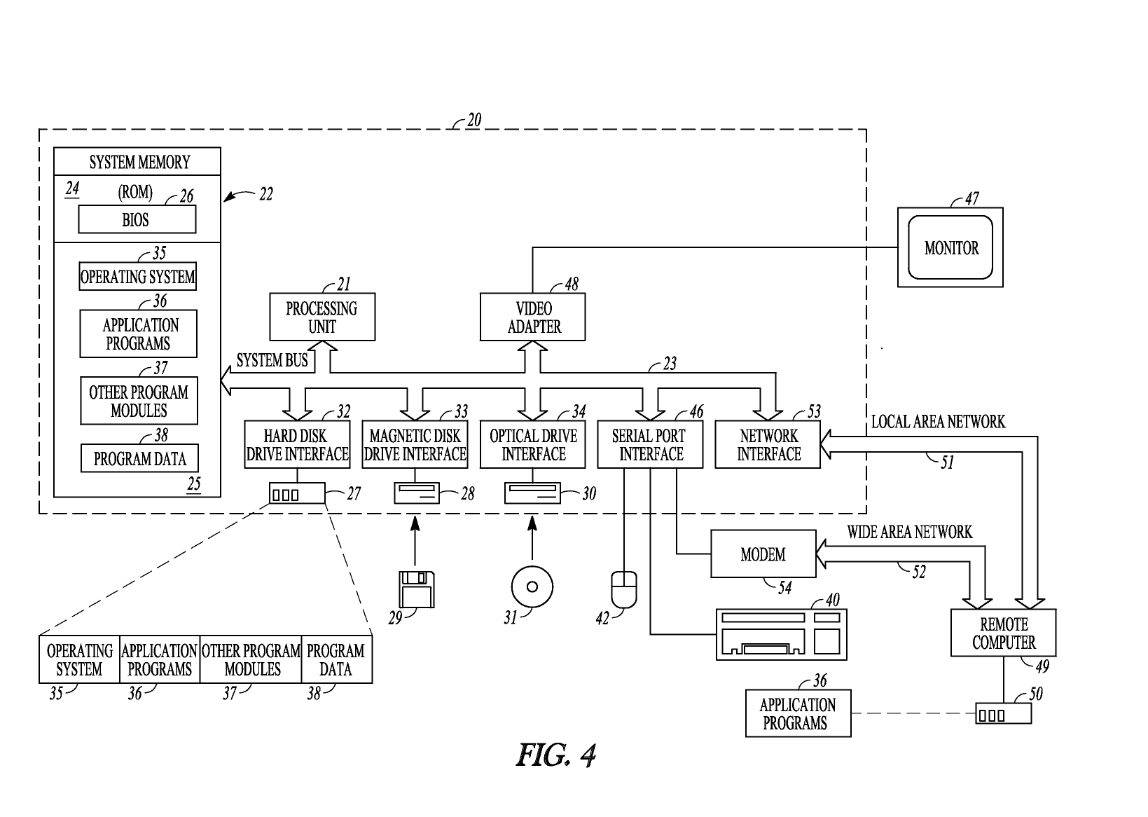

FIG. 4 is an overview diagram of hardware and operating environment in conjunction with which embodiments of the invention may be practiced. The description of FIG. 4 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 4, a hardware and operating environment is provided that is applicable to any of the servers and/or remote clients shown in the other Figures.

As shown in FIG. 4, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 47 can display a graphical user interface for the user. In addition to the monitor 47, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 4 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

1. A system comprising:
a computer processor operable to:
receive from a mobile device a request to create a virtual payment account, the virtual payment account associated with one or more of a bank account, a credit card account, and a prepaid account;
create the virtual payment account;
transmit an authorization token to the mobile device, wherein the authorization token is associated with the virtual payment account, wherein the authorization token is configured such that the authorization token enables the mobile device to create a barcode or quality code, and wherein the barcode or quality code comprises the authorization token;
receive from a point of sale device, in connection with a reading of the barcode or quality code and a purchase of a product or service, the authorization token and information relating to the product or service;
validate the authorization token received from the point of sale device;
compare the information relating to the product or service with information associated with the virtual payment account;
in response to the comparison, determine that there is a sufficient amount of funds associated with the virtual payment account to purchase the product or service, and authorize the purchase of the product or service;
in response to the comparison, determine that there is an insufficient amount of funds associated with the virtual payment account to purchase the product or service, and deny the purchase of the product or service;
transmit the authorization or the denial to the point of sale device; and
in response to the authorization of the purchase, apply a purchase amount to the bank account, the credit card account, or the prepaid account.

2. The system of claim 1, wherein the authorization token comprises a unique token identification, a customer identification, and a loyalty identification.

3. The system of claim 1, wherein the computer processor is operable to associate loyalty points with the virtual payment account.

4. The system of claim 1, wherein the computer processor is operable to impart the authorization token with a limited time of validity.

5. The system of claim 1, wherein the computer processor is operable to transmit a mobile application to the user device, the mobile application operable to collect user data from the user of the mobile device, the user data relating to the creation of the virtual payment account.

6. The system of claim 1, wherein the transmission of the authorization token to the mobile device is in response to a request for the authorization token from the mobile device.

7. The system of claim 6, wherein an application on the mobile device generates the request for the authorization token.

8. The system of claim 6, wherein the request for the authorization token from the mobile device and the transmission of the authorization token by the computer processor occurs via a wireless Internet connection or other wireless connection.

9. The system of claim 1, wherein the authorization token and information relating to the product or service received from the point of sale device is received via a wired connection.

10. The system of claim 1, wherein the computer processor is operable to delete the authorization token after the authorization or denial of the purchase.

11. The system of claim 1, wherein the computer processor is operable to transmit the authorization or denial to the mobile device.

12. A system comprising:
a computer processor operable to:
transmit an authorization token to a mobile device, wherein the authorization token is associated with a virtual payment account, wherein the virtual payment account is associated with one or more of a bank account, a credit card account, and a prepaid account, wherein the authorization token is configured such that the authorization token enables the mobile device to create a barcode or quality code, and wherein the barcode or quality code comprises the authorization token;
receive from a point of sale device, in connection with a reading of the barcode or quality code and a purchase of a product or service, the authorization token and information relating to the product or service;
validate the authorization token received from the point of sale device;
compare the information relating to the product or service with information associated with the virtual payment account;
in response to the comparison, determine that there is a sufficient amount of funds associated with the virtual payment account to purchase the product or service, and authorize the purchase of the product or service;
in response to the comparison, determine that there is an insufficient amount of funds associated with the virtual payment account to purchase the product or service, and deny the purchase of the product or service;
transmit the authorization or denial to the point of sale device; and
in response to the authorization of the purchase, apply a purchase amount to the bank account, the credit card account, or the prepaid account.

13. The system of claim 12, wherein the computer processor is operable to:
receive from the mobile device a request to create the virtual payment account; and
create the virtual payment account.

14. A computer readable medium comprising instructions that when executed by a processor execute a process comprising:
receiving from a mobile device a request to create a virtual payment account, the virtual payment account associated with one or more of a bank account, a credit card account, and a prepaid account;
creating the virtual payment account;
transmitting an authorization token to the mobile device, wherein the authorization token is associated with the virtual payment account, wherein the authorization token is configured such that the authorization token enables the mobile device to create a barcode or quality code, and wherein the barcode or quality code comprises the authorization token;
receiving from a point of sale device, in connection with a reading of the barcode or quality code and a purchase of a product or service, the authorization token and information relating to the product or service;
validating the authorization token received from the point of sale device;
comparing the information relating to the product or service with information associated with the virtual payment account;
in response to the comparison, determining that there is a sufficient amount of funds associated with the virtual payment account to purchase the product or service, and authorizing the purchase of the product or service;
in response to the comparison, determining that there is an insufficient amount of funds associated with the virtual payment account to purchase the product or service, and denying the purchase of the product or service;
transmitting the authorization or the denial to the point of sale device; and
in response to the authorization of the purchase, applying a purchase amount to the bank account, the credit card account, or the prepaid account.

15. The computer readable medium of claim 14, comprising instructions for imparting the authorization token with a limited time of validity.

16. The computer readable medium of claim 14, comprising instructions for transmitting a mobile application to the user device, the mobile application operable to collect user data from the user of the mobile device, the user data relating to the creation of the virtual payment account.

17. The computer readable medium of claim 14, comprising instructions such that the transmission of the authorization token to the mobile device is in response to a request for the authorization token from the mobile device.

18. The computer readable medium of claim 14, comprising instructions such that the authorization token and information relating to the product or service received from the point of sale device are received via a wired connection.

19. The computer readable medium of claim 14, comprising instructions for deleting the authorization token after the authorization or denial of the purchase.

20. The computer readable medium of claim 14, comprising instructions for transmitting the authorization or denial to the mobile device.
